(19) United States
(12) Patent Application Publication
(10) Pub. No.: US 2008/0285497 A1
(43) Pub. Date: Nov. 20, 2008

(54) Apparatus, method, and computer program product providing improved point-to-multipoint communication in a wimax system

(75) Inventors: Roman Pichna, Espoo (FI); Zexian Li, Espoo (FI); Ravi Pandey, Espoo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/803,759

(22) Filed: May 15, 2007

(51) Int. Cl. H04H 1/00

(52) U.S. Cl. 370/312

(57) ABSTRACT

The exemplary embodiments of the invention describe apparatus, methods and computer program products that provide a guide and control channel in a WiMAX system to facilitate point-to-multipoint (p-t-m) channel identification, transmission and/or reception. In one non-limiting, exemplary embodiment, a method includes: accessing a p-t-m guide; and transmitting the p-t-m guide using a predetermined IP address on a predetermined channel in a WiMAX system. In another non-limiting, exemplary embodiment, a method includes: receiving a p-t-m guide on a predetermined IP address of a predetermined channel in a WiMAX system; extracting p-t-m session information from the p-t-m guide; selecting a transmission to receive based on the extracted p-t-m session information; and receiving the selected transmission.

### TECHNICAL FIELD

The exemplary embodiments of this invention relate generally to wireless communication systems and, more specifically, relate to point-to-multipoint transmissions in a WiMAX system.

### BACKGROUND

The following abbreviations are utilized herein:

3GPP third generation partnership project

ALC asynchronous layered coding

BS base station

CID connection identifier

DL downlink (BS to MS)

DSL digital subscriber line

DVB-H digital video broadcasting-handheld (ETSI)

EPG electronic programming guide

ESG electronic service guide

ETSI European telecommunications standards institute

FLUTE file delivery over unidirectional transport

IE information element

IEEE institute of electrical and electronics engineers

IGMP internet group management protocol

IP internet protocol

IP-M internet protocol multicast

IPTV internet protocol television

IPv4 internet protocol version 4

IPv6 internet protocol version 6

L1 layer 1 (physical channel, PHY)

L2 layer 2 (link layer, MAC)

L3 layer 3 (IP)

MAC medium access control

MBI multicast bearer information

MBMS multimedia broadcast/multicast service (3GPP)

MBS multicast/broadcast service (IEEE 802.16e-2005)

MCBCS multicast/broadcast service (WiMAX multimedia broadcast/multicast service)

MLD multicast listener discovery

MS mobile station

PSI/SI program specific information/service information

p-t-m point-to-multipoint

SDP session description protocol

UDP user datagram protocol

WiMAX worldwide interoperability for microwave access (for IEEE 802.16 standard)

XML extensible markup language

Two examples of multicast/broadcast are 3GPP MBMS and broadband access IPTV. The 3GPP is working to produce standards for MBMS. In contrast, IPTV and IP data-cast technology is currently available and in use by DSL and DVB-H networks. The underlying architectures of MBMS and IPTV are similar in that they are both based on IP-multicast at the IP layer. However, in the case of DVB-H, the IP-multicast is mapped to the broadcast feature of the radio interface.

In DVB-H and DSL IPTV, an ESG programming channel is used to transfer programming information, including a SDP having an IP session description. Generally, the ESG includes the session description for layers L3 and above (i.e., L3+).

In DSL, the L3+ information is sufficient since a client can request to join a channel at the IP layer by issuing an IGMP join signal to the network. However, in broadcast media such as DVB-H, a client also needs lower layer parameters to “tune in” to the correct channel. Such information may also be needed to find the parameters of the broadcast channel carrying the ESG stream.

In DVB-H, the lower layer information is provided via the PSI/SI channel. The broadcast channel carries a lower layer bearer description, including the L3 information, such as the IP address carried in that particular bearer. Generally, this captures the session description for layer L3 and below (i.e., L3−). The mapping chain from an entertainment channel to physical parameters of the bearer can be completed by combining the higher layer information (via the ESG) and the lower layer information (via the PSI/SI).

### SUMMARY

In an exemplary aspect of the invention, a method includes: accessing a point-to-multipoint (p-t-m) guide; and transmitting the p-t-m guide using a predetermined IP address on a predetermined channel in a worldwide interoperability for microwave access (WiMAX—IEEE 802.16 standard) system.

In another exemplary aspect of the invention, a computer program product includes program instructions embodied on a tangible computer-readable medium. Execution of the program instructions results in operations including: accessing a point-to-multipoint (p-t-m) guide; and transmitting the p-t-m guide using a predetermined IP address on a predetermined channel in a worldwide interoperability for microwave access (WiMAX—IEEE 802.16 standard) system.

In a further exemplary aspect of the invention, an electronic device includes: a memory configured to store a point-to-multipoint (p-t-m) guide; a data processor configured to access the p-t-m guide; and a transmitter configured to transmit the p-t-m guide using a predetermined IP address on a predetermined channel, wherein the electronic device is a station in a worldwide interoperability for microwave access (WiMAX—IEEE 802.16 standard) system.

In another exemplary aspect of the invention, a method includes: receiving a point-to-multipoint (p-t-m) guide on a predetermined IP address of a predetermined channel in a worldwide interoperability for microwave access (WiMAX—IEEE 802.16 standard) system; extracting p-t-m session information from the p-t-m guide; selecting a transmission to receive based on the extracted p-t-m session information; and receiving the selected transmission.

In a further exemplary aspect of the invention, a computer program product includes program instructions embodied on a tangible computer-readable medium. Execution of the program instructions results in operations including: receiving a point-to-multipoint (p-t-m) guide on a predetermined IP address of a predetermined channel in a worldwide interoperability for microwave access (WiMAX—IEEE 802.16 standard) system; extracting p-t-m session information from the p-t-m guide; selecting a transmission to receive based on the extracted p-t-m session information; and receiving the selected transmission.

In another exemplary aspect of the invention, an electronic device includes: a receiver configured to receiving a point-to-multipoint (p-t-m) guide on a predetermined IP address of a predetermined channel; a data processor configured to extract p-t-m session information from the p-t-m guide and to select a transmission to receive based on the extracted p-t-m session information, wherein the receiver is further configured to receive the selected transmission, wherein the electronic device is a station in a worldwide interoperability for microwave access (WiMAX—IEEE 802.16 standard) system.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 shows an exemplary frame structure for WiMAX frames having multicast and/or broadcast elements;

FIG. 2 illustrates a simplified block diagram of an electronic device that is suitable for use in practicing the exemplary embodiments of this invention;

FIG. 3 shows an exemplary signaling chart for transmissions between a MS and a BS in an exemplary WiMAX network utilizing aspects of the exemplary embodiments of the invention;

FIG. 4 depicts a flowchart illustrating one non-limiting example of a method for practicing the exemplary embodiments of this invention; and

FIG. 5 depicts a flowchart illustrating another non-limiting example of a method for practicing the exemplary embodiments of this invention.

### DETAILED DESCRIPTION

Reference with regard to WiMAX generally may be made to IEEE Std 802.16e™-2005, “IEEE Standard for Local and metropolitan area networks; Part 16: Air Interface for Fixed and Mobile Broadband Wireless Access Systems; Amendment 2: Physical and Medium Access Control Layers for Combined Fixed and Mobile Operation in Licensed Bands; and Corrigendum 1,” IEEE Computer Society and the IEEE Microwave Theory and Techniques Society (referred to herein as “802.16e-2005”).

Further reference with regard to WiMAX generally may be made to “WiMAX End-to-End Network Systems Architecture (Stage 2: Architecture Tenets, Reference Model and Reference Points),” Release 1, Mar. 28, 2007, and “WiMAX End-to-End Network Systems Architecture (Stage 3: Detailed Protocols and Procedures),” Release 1, Mar. 28, 2007.

There is some support in 802.16e-2005 for p-t-m transmissions (e.g., multicast and broadcast). Note that in a WiMAX system, there is no such PSI/SI-like channel available. However, the MBS-MAP IEs carry information for layers below L3 (e.g., the MBS-CID).

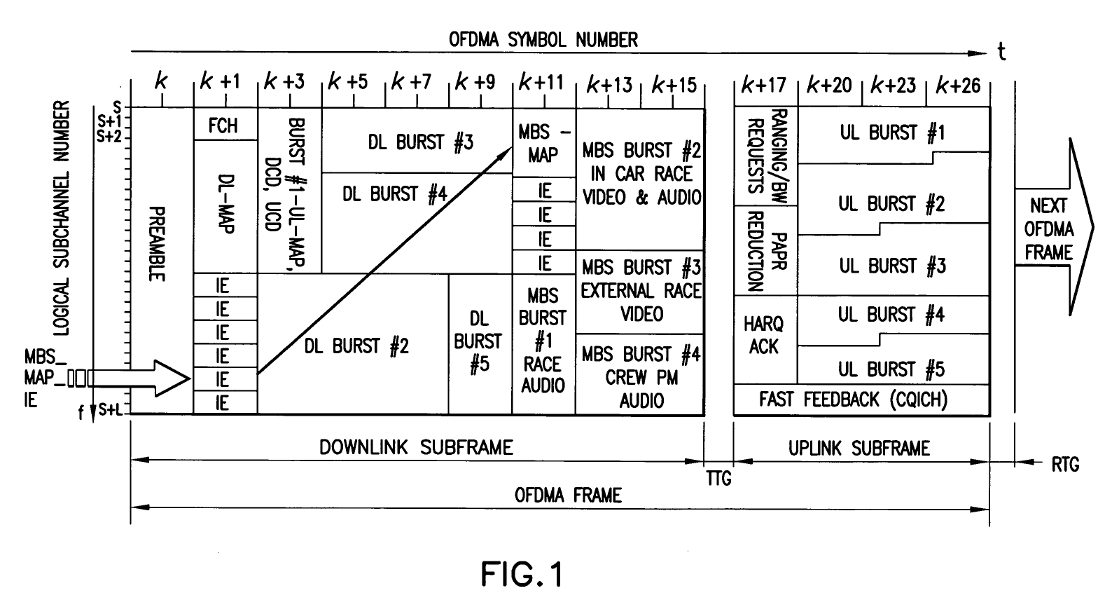

FIG. 1 shows an exemplary frame structure for WiMAX frames having multicast and/or broadcast elements.

In order for a MS to find the MCBCS portion in a WiMAX frame, the BS transmits a MBS_MAP_IE in the DL-MAP. The MBS_MAP_IE indicates when the next data for a MCBCS service flow will be transmitted. After receiving the DL-MAP message, a MS will know the starting location of the MCBCS portion. Because there may be more than one MBS burst, another MAP message, MBS_MAP, is used. The MBS_MAP message is located in the first subchannel and first OFDMA symbol of the MBS region and is used to describe the MBS connections serviced by the MBS portion. From the MBS_MAP message, a MS can determine various pieces of information such as how many channels are served, the corresponding multicast CIDs and subchannel information.

In summary, a MS finds a MBS subchannel by: (1) finding the location of MBS_MAP from the MBS_MAP_IE in the DL-MAP; and (2) finding a specific MBS subchannel from the MBS_MAP.

The exemplary embodiments of the invention provide a guide and control channel in a WiMAX system to facilitate p-t-m channel identification, transmission and/or reception. By transmitting a p-t-m guide using a predetermined IP address on a predetermined channel, a MS in the WiMAX system will know where to find p-t-m session information. After having obtained the p-t-m session information, the MS then receives the p-t-m transmission. In other exemplary embodiments, the MS transmits a request to join a specific channel (e.g., an identified channel). In response to receiving such a request, a BS processes the request and transmits the identified channel. In further embodiments, the BS also transmits additional session information that the MS uses in order to receive the identified channel. In other embodiments, the MS stops reception of the identified channel and transmits a leave message. In response to receiving such a leave message from a last user receiving the identified channel, the BS stops transmitting the identified channel. As further described below, the exemplary embodiments of the invention are particularly suitable for use in conjunction with broadcast transmissions or multicast transmissions, as non-limiting examples.

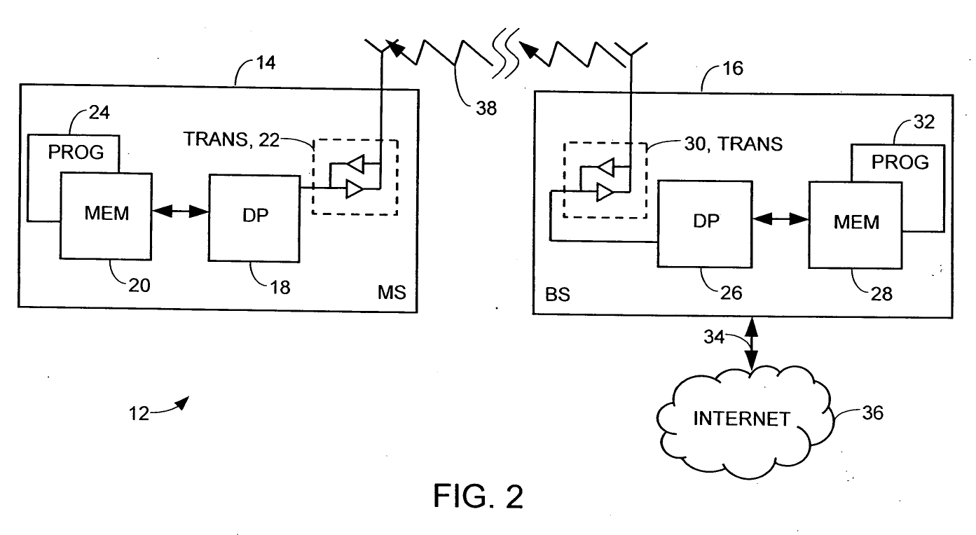

Reference is made to FIG. 2 for illustrating a simplified block diagram of various electronic devices that are suitable for use in practicing the exemplary embodiments of this invention. In FIG. 2, a WiMAX wireless network 12 is adapted for communication with a mobile station (MS) 14 via a base station (BS) 16. The MS 14 includes a data processor (DP) 18, a memory (MEM) 20 coupled to the DP 18, and a suitable RF transceiver (TRANS) 22 (having a transmitter (TX) and a receiver (RX)) coupled to the DP 18. The MEM 20 stores a program (PROG) 24. The TRANS 22 is for wireless communications from or with the BS 16 via a wireless connection data path 38. Note that the TRANS 22 has at least one antenna to facilitate communication.

The BS 16 includes a data processor (DP) 26, a memory (MEM) 28 coupled to the DP 26, and a suitable RF transceiver (TRANS) 30 (having a transmitter (TX) and a receiver (RX)) coupled to the DP 26. The MEM 28 stores a program (PROG) 32. The TRANS 30 is for wireless communications to or with the MS 14 via a wireless connection data path 38. Note that the TRANS 30 has at least one antenna to facilitate communication. The BS 16 is coupled via a data path 34 to one or more external networks or systems, such as the internet 36, for example.

At least one of the PROGs 24, 32 is assumed to include program instructions that, when executed by the associated DP, enable the electronic device to operate in accordance with the exemplary embodiments of this invention, as discussed herein.

In general, the various embodiments of the MS 14 can include, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by one or more of the DPs 18, 26 of the MS 14 and the BS 16, or by hardware, or by a combination of software and hardware. As a non-limiting example, the exemplary embodiments of this invention may be implemented utilizing circuitry and/or integrated circuits.

The MEMs 20, 28 may be of any type suitable to the local technical environment and may be implemented using any suitable data storage technology, such as semiconductor-based memory devices, magnetic memory devices and systems, optical memory devices and systems, fixed memory and removable memory, as non-limiting examples. The DPs 18, 26 may be of any type suitable to the local technical environment, and may include one or more of general purpose computers, special purpose computers, microprocessors, digital signal processors (DSPs) and processors based on a multi-core processor architecture, as non-limiting examples.

The wireless connection data path 38 may be unidirectional (as shown in FIG. 2—from the BS 16 to the MS 14) or bidirectional. As non-limiting examples, communications via the wireless connection data path 38 may comprise broadcast transmissions (from the BS 16 to a surrounding area in which the MS 14 is located), multicast transmissions (from the BS 16 to a particular group of subscribers which comprises the MS 14) or a combination thereof. Although shown in FIG. 2 as having a TRANS 30, in other exemplary embodiments the BS 16 may instead comprise a transmitter (e.g., for broadcast transmissions which the MS 14 receives via the wireless connection data path 38). In further exemplary embodiments, the MS 14, the BS 16 or both the MS 14 and the BS 16 may comprise a plurality of transceivers and/or a plurality of antennas. In other exemplary embodiments, the BS 16 may comprise at least one transmitter and at least one transceiver, wherein the transmitter is utilized for point-to-multipoint transmissions.

In one non-limiting, exemplary embodiment, a WiMAX system 12 has at least one BS 16 and at least one MS 14, as described above with respect to FIG. 2. The BS 16 transmits a broadcast transmission on a predetermined channel 38 (e.g., a channel having a known or predetermined CID). The broadcast transmission comprises a p-t-m guide transmitted using a predetermined IP address. The MS 14 receives the p-t-m guide and extracts session information (e.g., p-t-m session information) from the p-t-m guide. Based on the extracted session information, the MS 14 selects a transmission to receive. As non-limiting example, the transmission may comprise a broadcast transmission or a multicast transmission. Using the extracted p-t-m session information, the MS 14 receives the selected transmission. If the transmission is a multicast transmission, the MS 14 may transmit a join message (e.g., a join request) to the BS 16. In response to receiving such a join message, the BS 16 may process it and act accordingly to enable the MS 14 to receive the requested multicast transmission. As a non-limiting example, the BS 16 may include additional session information for the multicast transmission in the broadcast transmission. The MS 14 may utilize the additional session information to receive the multicast transmission. When the MS 14 desires to stop reception of the multicast transmission, the MS 14 may transmit a leave message to the BS 16 to notify the BS 16 that the MS 14 is ceasing reception of the transmission. If the MS 14 comprises the last user receiving the transmission, the BS 16 may cease transmitting the multicast transmission in response to receiving a leave message from the MS 14.

In another non-limiting, exemplary embodiment, a WiMAX system has at least one BS and at least one MS. The BS periodically transmits a broadcast transmission on a predetermined channel having a predetermined MBS-CID. Note that according to Section 10.4 and Table 345 of 802.16e-2005, the address for a MBS-CID ranges from 0xFEA0 to 0xFEFE. As a non-limiting example, one suitable value for the predetermined MBS-CID comprises 0xFEA0.

The broadcast transmission comprises at least two IP streams, a first IP stream and a second IP stream, that each use a different predetermined (e.g., known) IP address. The first IP stream carries ESG information while the second IP stream carries MBI. The structure of these streams (e.g., channels) may comprise any structure, architecture or arrangement suitable for use within a WiMAX system. As non-limiting examples, one or both of the streams may be structured to approximate DVB-H by using XML files to carry the ESG and MBI data. As a further non-limiting example, the transport of such XML files also can be performed similar to DVB-H using IP, UDP, ALC, FLUTE or XML, as non-limiting examples. Reference with regard to ALC protocol may be made to RFC3450, “Asynchronous Layered Coding (ALC) Protocol Instantiation,” Luby et al., December 2002. Reference with regard to FLUTE protocol may be made to RFC3926, “FLUTE—File Delivery over Unidirectional Transport,” Paila et al., October 2004.

The ESG carries session information for layers L3 and above (e.g., SDP). Note that there may be several p-t-m operators sharing one WiMAX access. In such a case, there may be a hierarchy of ESGs carried in the control channel (the MBS-CID). As a non-limiting example, the ESG may be IP-multicast from a centralized node (e.g., BS).

The MBI carries session information for layers L3 and below. For example, the MBI may comprise at least IP-M address (and UDP port) to MBS-CID mapping information. As a non-limiting example, BS-specific multicast information (MBI) may be transmitted (e.g., broadcasted). As another non-limiting example, the MBI may be IP multicast from a central node to all corresponding BSs. This would imply that the multicast channel L2 identities (MBS-CIDs) and MBS-CID-to-IP@/UDP_port mapping would be identical for all BSs in the access network that share the same IP multicast tree for the MBI multicast.

Note that 802.16e-2005 does provide for a dedicated broadcast channel having a broadcast CID. Section 10.4 and Table 345 indicate that the value for the broadcast CID is 0xFFFF. While this broadcast CID might be used to carry p-t-m (e.g., broadcast/multicast) streams, such a use would likely impose limitations and/or additional burdens on other uses of the broadcast CID. For example, if television programming were transmitted via the broadcast CID, all receivers desiring to periodically update the control information would have to demodulate the entire burst and discriminate, at a higher layer, between the broadband user plane (having the television programming) and the narrowband control plane (having the control information).

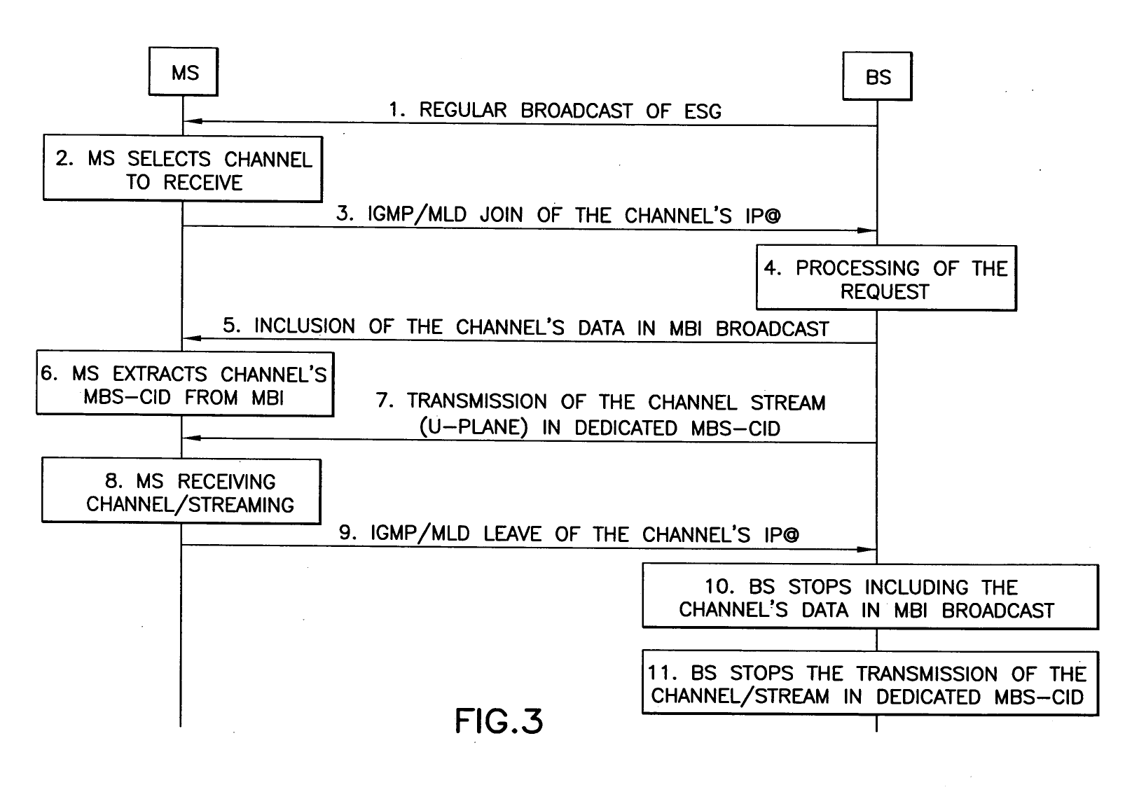

The above-described exemplary embodiment allows a MS to find ESG information by tuning to the predefined MBS-CID. Once tuned in, the MS could receive the ESG and MBI streams, for example, to create and periodically update MS-local mapping tables. The MS could then select a channel and, based on the selected channel's IP address, find the respective MBS-CID-to-IP@/UDP_port mapping. A non-limiting example of this procedure is described below with respect to FIG. 3.

FIG. 3 shows an exemplary signaling chart for transmissions between a MS and, a BS in an exemplary WiMAX network utilizing aspects of the exemplary embodiments of the invention.

In step 1, the BS regularly (e.g., periodically) broadcasts an ESG. In step 2, the MS finds and receives the ESG because the MS knows the predetermined (dedicated) MBS-CID for the control channel in addition to the predetermined IP address used for the ESG. The MS extracts session description information from the ESG. The MS then selects a transmission (e.g., a channel or stream) to receive based on the extracted session description information. If, for example, the selected transmission comprises a broadcast transmission, the MS simply tunes in to the selected broadcast transmission using the session description information.

In step 3, if, for example, the selected transmission comprises a multicast transmission, the MS may have to send a request to the BS in order to receive additional session information and join the group to receive the multicast transmission. For example, the MS may issue (e.g., transmit) an IGMP (IPv4) or MLD (IPv6)join message to the BS for the selected transmission. For convenience, in this exemplary embodiment, and as discussed with respect to FIG. 3, it will be assumed that the selected transmission comprises a selected channel.

In step 4, the BS receives the join message. The BS and/or a connected network processes the request. In step 5, the BS includes the selected channel's data (i.e., additional session description information corresponding to the selected multicast channel) in a MBI that is also regularly broadcast in conjunction with the regular broadcasting of the ESG. As a non-limiting example, the selected channel's data may comprise L3-to-L2 mapping information (IP@+UDP_port-to-MBS-CID mapping) for the selected channel. In some exemplary embodiments, step 5 is performed only if the selected channel's data is not already being transmitted for other MSs.

In step 6, the MS receives the selected channel's data in the MBI and obtains (e.g., extracts) the selected channel's MBS-CID (e.g., L2 coordinates) from the received MBI. In step 7, the BS transmits the selected channel stream (e.g., U-plane) in a dedicated channel having a dedicated MBS-CID. In some exemplary embodiments, step 7 is performed only if the selected channel is not already being transmitted for other MSs. In step 8, the MS receives the selected channel.

In step 9, the MS issues an IGMP/MLD leave message to the BS to stop receiving the selected channel. That is, the MS transmits the leave message to the BS to inform the BS that the MS is going to cease reception of the selected channel. In step 10, in response to receiving the leave message, if the MS was the last user receiving the selected channel, the BS stops transmitting the MBI. In step 1, in response to receiving the leave message, if the MS was the last user receiving the selected channel, the BS stops transmitting the selected channel.

In other exemplary embodiments, steps 6 and 7 are performed concurrently. In further exemplary embodiments, steps 6 and 7 are performed in reverse order. In other exemplary embodiments, steps 5 and 7 are performed concurrently. In further exemplary embodiments, steps 5 and 7 are performed in reverse order.

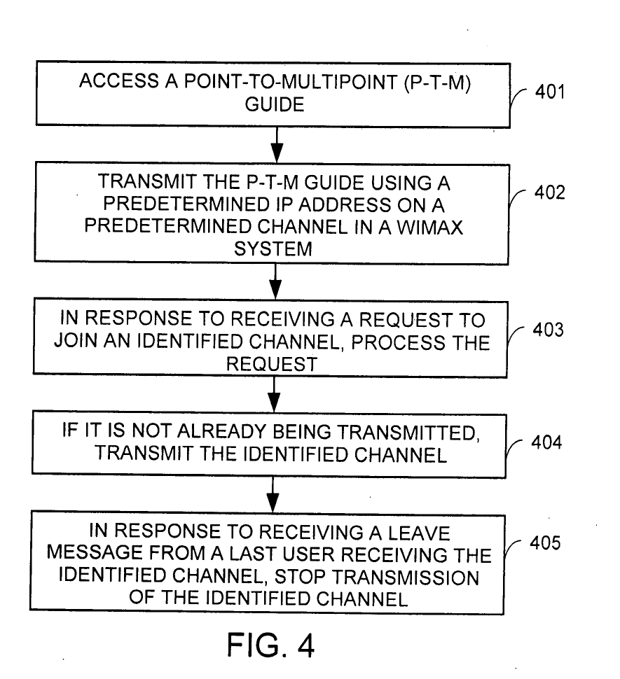

In one non-limiting, exemplary embodiment, and as shown in FIG. 4, a method comprises: accessing a point-to-multipoint (p-t-m) guide (box 401); and transmitting the p-t-m guide using a predetermined IP address on a predetermined channel in a worldwide interoperability for microwave access (WiMAX—IEEE 802.16 standard) system (box 402). As a non-limiting example, the method depicted by FIG. 4, and as further described below, may be performed by a BS in the WiMAX system. As a non-limiting example, accessing the p-t-m guide may comprise retrieving the p-t-m guide from a storage medium (e.g., a memory).

In other exemplary embodiments, the method further comprises: in response to receiving a request to join an identified channel, processing the request (box 403); and, in response to receiving the request to join the identified channel, if it is not already being transmitted, transmitting the identified channel (box 404). In further exemplary embodiments, the method further comprises: in response to receiving a leave message from a last user receiving the identified channel, stopping transmission of the identified channel (box 405).

In other exemplary embodiments, the p-t-m guide is transmitted periodically. In further exemplary embodiments, the p-t-m guide comprises p-t-m session information for a layer L3 and layers above L3. In other exemplary embodiments, the p-t-m guide comprises an electronic service guide having p-t-m session information for a layer L3 and layers above L3. In further exemplary embodiments, a multicast transmission is transmitted on the identified channel. In other exemplary embodiments, the p-t-m guide further comprises multicast bearer information (MBI), wherein the MBI comprises the additional session information. In other exemplary embodiments, the MBI comprises p-t-m session information for a layer L3 and layers below L3. In further exemplary embodiments, the MBI comprises L3-to-L2 multicast mapping information.

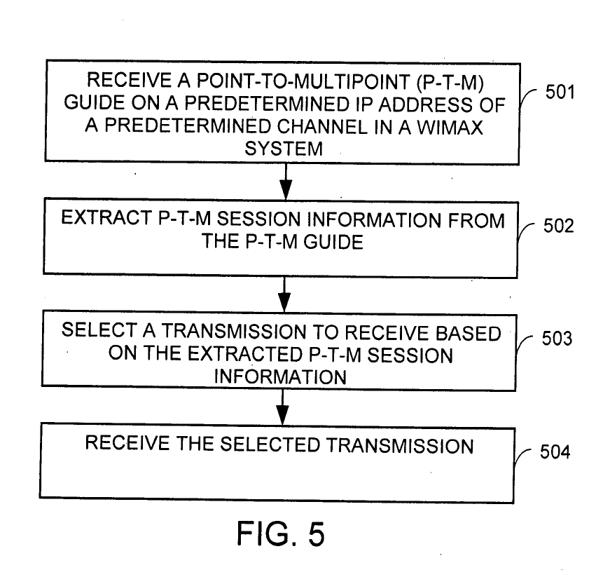

In another non-limiting, exemplary embodiment, and as shown in FIG. 5, a method comprises: receiving a point-to-multipoint (p-t-m) guide on a predetermined IP address of a predetermined channel in a worldwide interoperability for microwave access (WiMAX—IEEE 802.16 standard) system (box 501); extracting p-t-m session information from the p-t-m guide (box 502); selecting a transmission to receive based on the extracted p-t-m session information (box 503); and receiving the selected transmission (box 504). As a non-limiting example, the method depicted by FIG. 5, and as further described below, may be performed by a MS in the WiMAX system.

In other exemplary embodiments, wherein the selected transmission is transmitted on an identified channel, the method further comprises: transmitting a request to join an identified channel; receiving additional session information for the identified channel; and receiving the identified channel using the additional session information. In further exemplary embodiments, the method further comprises: transmitting a leave message; and stopping reception of the identified channel.

In other exemplary embodiments, the p-t-m guide comprises an electronic service guide having p-t-m session information for a layer L3 and layers above L3. In further exemplary embodiments, the selected transmission comprises at least one of a broadcast transmission and a multicast transmission. In other exemplary embodiments, the p-t-m guide comprises multicast bearer information (MBI), wherein the MBI comprises the additional session information. In further exemplary embodiments, the MBI comprises L3-to-L2 multicast mapping information.

The exemplary embodiments of the invention, as discussed above and as particularly described with respect to exemplary methods, may be implemented as a computer program product comprising program instructions embodied on a tangible computer-readable medium. Execution of the program instructions results in operations comprising steps of utilizing the exemplary embodiments or steps of the method.

While the exemplary embodiments have been described above in the context of a WiMAX system, it should be appreciated that the exemplary embodiments of this invention are not limited for use with only this one particular type of wireless communication system, and that they may be used to advantage in other wireless communication systems.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

Furthermore, some of the features of the preferred embodiments of this invention could be used to advantage without the corresponding use of other features. As such, the foregoing description should be considered as merely illustrative of the principles of the invention, and not in limitation thereof.

What is claimed is:

1. A method comprising:
accessing a point-to-multipoint (p-t-m) guide; and
transmitting the p-t-m guide using a predetermined IP address on a predetermined channel in a worldwide interoperability for microwave access (WiMAX—IEEE 802.16 standard) system.

2. The method of claim 1, wherein the p-t-m guide is transmitted periodically.

3. The method of claim 1, wherein the p-t-m guide comprises p-t-m session information for a layer L3 and layers above L3.

4. The method of claim 1, wherein the p-t-m guide comprises an electronic service guide having p-t-m session information for a layer L3 and layers above L3.

5. The method of claim 1, further comprising:
in response to receiving a request to join an identified channel, processing the request; and
in response to receiving the request to join the identified channel, if it is not already being transmitted, transmitting the identified channel.

6. The method of claim 5, wherein a multicast transmission is transmitted on the identified channel.

7. The method of claim 5, further comprising:
in response to receiving the request to join the identified channel, if it is not already being transmitted, transmitting additional session information for the identified channel.

8. The method of claim 7, wherein the p-t-m guide further comprises multicast bearer information (MBI), wherein the MBI comprises the additional session information.

9. The method of claim 8, wherein the MBI comprises p-t-m session information for a layer L3 and layers below L3.

10. The method of claim 8, wherein the MBI comprises L3-to-L2 multicast mapping information.

11. The method of claim 5, further comprising:
in response to receiving a leave message from a last user receiving the identified channel, stopping transmission of the identified channel.

12. A computer program product comprising program instructions embodied on a tangible computer-readable medium, execution of the program instructions resulting in operations comprising:
accessing a point-to-multipoint (p-t-m) guide; and
transmitting the p-t-m guide using a predetermined IP address on a predetermined channel in a worldwide interoperability for microwave access (WiMAX—IEEE 802.16 standard) system.

13. The computer program product of claim 12, execution of the program instructions resulting in operations further comprising:
in response to receiving a request to join an identified channel, processing the request; and
in response to receiving the request to join the identified channel, if it is not already being transmitted, transmitting the identified channel.

14. The computer program product of claim 13, execution of the program instructions resulting in operations further comprising:
in response to receiving the request to join the identified channel, if it is not already being transmitted, transmitting additional session information for the identified channel.

15. The computer program product of claim 14, wherein the p-t-m guide comprises an electronic service guide having p-t-m session information for a layer L3 and layers above L3, wherein the p-t-m guide further comprises multicast bearer information (MBI), wherein the MBI comprises the additional session information, wherein the MBI comprises L3-to-L2 multicast mapping information.

16. An electronic device comprising:
a memory configured to store a point-to-multipoint (p-t-m) guide;
a data processor configured to access the p-t-m guide; and
a transmitter configured to transmit the p-t-m guide using a predetermined IP address on a predetermined channel, wherein the electronic device comprises a station in a worldwide interoperability for microwave access (WiMAX—IEEE 802.16 standard) system.

17. The electronic device of claim 16, further comprising:
a receiver configured to receive a request to join an identified channel, wherein the data processor is further configured, in response to receiving the request to join the identified channel, to process the request, wherein the transmitter is configured, in response to receiving the request to join the identified channel, to transmit the identified channel if the identified channel is not already being transmitted.

18. The electronic device of claim 17, wherein the transmitter is configured, in response to receiving the request to join the identified channel, to transmit additional session information for the identified channel if the additional session information is not already being transmitted.

19. The electronic device of claim 16, wherein the electronic device comprises a base station.

20. A method comprising:
receiving a point-to-multipoint (p-t-m) guide on a predetermined IP address of a predetermined channel in a worldwide interoperability for microwave access (WiMAX—IEEE 802.16 standard) system;
extracting p-t-m session information from the p-t-m guide;
selecting a transmission to receive based on the extracted p-t-m session information; and
receiving the selected transmission.

21. The method of claim 20, wherein the p-t-m guide comprises an electronic service guide having p-t-m session information for a layer L3 and layers above L3.

22. The method of claim 20, wherein the selected transmission comprises at least one of a broadcast transmission and a multicast transmission.

23. The method of claim 20, wherein the selected transmission is transmitted on an identified channel, further comprising:
transmitting a request to join an identified channel corresponding to the selected transmission; and
receiving additional session information for the identified channel.

24. The method of claim 23, wherein the p-t-m guide comprises multicast bearer information (MBI), wherein the MBI comprises the additional session information.

25. The method of claim 24, wherein the MBI comprises L3-to-L2 multicast mapping information.

26. The method of claim 20, further comprising:
transmitting a leave message; and
stopping reception of the selected transmission.

27. A computer program product comprising program instructions embodied on a tangible computer-readable medium, execution of the program instructions resulting in operations comprising:
receiving a point-to-multipoint (p-t-m) guide on a predetermined IP address of a predetermined channel in a worldwide interoperability for microwave access (WiMAX—IEEE 802.16 standard) system;
extracting p-t-m session information from the p-t-m guide;
selecting a transmission to receive based on the extracted p-t-m session information; and
receiving the selected transmission.

28. The computer program product of claim 27, execution of the program instructions resulting in operations further comprising:
transmitting a request to join an identified channel corresponding to the selected transmission; and
receiving additional session information for the identified channel.

29. The computer program product of claim 28, wherein the p-t-m guide comprises an electronic service guide having p-t-m session information for a layer L3 and layers above L3, wherein the p-t-m guide further comprises multicast bearer information (MBI), wherein the MBI comprises the additional session information, wherein the MBI comprises L3-to-L2 multicast mapping information.

30. The computer program product of claim 27, execution of the program instructions resulting in operations further comprising:
transmitting a leave message; and
stopping reception of the selected transmission.

31. An electronic device comprising:
a receiver configured to receiving a point-to-multipoint (p-t-m) guide on a predetermined IP address of a predetermined channel;
a data processor configured to extract p-t-m session information from the p-t-m guide and to select a transmission to receive based on the extracted p-t-m session information, wherein the receiver is further configured to receive the selected transmission, wherein the electronic device comprises a station in a worldwide interoperability for microwave access (WiMAX—IEEE 802.16 standard) system.

32. The electronic device of claim 31, further comprising:
a transmitter configured to transmit a request to join an identified channel corresponding to the selected transmission, wherein the receiver is further configured to receive additional session information for the identified channel.

33. The electronic device of claim 32, wherein the p-t-m guide comprises an electronic service guide having p-t-m session information for a layer L3 and layers above L3, wherein the p-t-m guide further comprises multicast bearer information (MBI), wherein the MBI comprises the additional session information, wherein the MBI comprises L3-to-L2 multicast mapping-information.

34. The electronic device of claim 31, further comprising:
a transmitter configured to transmit a leave message, wherein the data processor is further configured to stop reception of the selected transmission.

35. The electronic device of claim 31, wherein the electronic device comprises a mobile station.
